(19) United States
(12) Patent Application Publication
(10) Pub. No.: US 2002/0196123 A1
(43) Pub. Date: Dec. 26, 2002

(54) Portable locking systems

(75) Inventors: Joseph Raymond Diehl, Hamilton, OH (US); Don Randell Greer, Hamilton, CA (US); Hyundae Hong, West Chester, OH (US); Donald Carroll Roe, West Chester, OH (US)

Correspondence Address: THE PROCTER & GAMBLE COMPANY, PATENT DIVISION, SHARON WOODS TECHNICAL CENTER - BOX C15, 11450 GROOMS ROAD, CINCINNATI, OH, 45242, US

(73) Assignee: The Procter & Gamble Company

(21) Appl. No.: 09/892,049

(22) Filed: Jun. 26, 2001

(51) Int. Cl. G05B 19/00

(52) U.S. Cl. 340/5.64

(57) ABSTRACT

Disclosed are portable locking systems that primarily provide for the controlled entrance into lockable structures such as home cabinets. The portable locking systems comprise a portable transmitter and a portable receiver wherein the portable receiver preferably has a locking mechanism connected to the receiver. The portable transmitter is hand-held or removable from an individual to another individual whereas the portable receiver is removable from a lockable structure such as a home cabinet for reattachment to another cabinet or other lockable structure, thus resulting in a portable locking system that can be used temporarily or permanently at home or transported to another location for use.

### FIELD OF INVENTION

The present invention relates to portable locking systems which are effective in the controlled entrance of lockable structures. In particular, the present invention relates to portable locking systems which comprise a portable transmitter and portable receiver units which provide for locking systems that are highly effective in the controlled entrance of lockable structures such as home cabinets.

### BACKGROUND OF THE INVENTION

Controlled entrance into units such as cabinets, cars, doors, buildings, homes, vending machines, and the like, has been a successful and proven technique which utilizes some commonly known locking devices, examples of which include keyless entry systems, dead-bolts, and security/alarm locking systems. Locking devices such as keyless entry systems and security/alarm locking systems are preferred because they provide the consumer with a convenient automatic or semi-automatic mean of securing or locking a structure as compared to the standard key locking mechanism.

Automatic or semi-automatic locking devices can be described as radio-frequency controlled units which typically consist of a transmitter for generating a signal to a receiver that correlates the locking and unlocking of locking mechanisms attached or mechanically linked to lockable structures. These locking devices allow the consumer to remotely lock and unlock the locking mechanisms, thus providing the consumer with a desirable popular method of indirectly controlling the locking and unlocking of structures such as car doors and buildings.

However, some automatic and semi-automatic locking devices are not theft-proof, require coded signal generators, can inadvertently transmit a signal to lock or unlock an unintended locking mechanism, or can only operate within a specific range or proximity. Despite some existing limitations with some commonly known locking devices, these locking devices have still been found to generally meet the consumer needs. Improvements in the industry thus continue in order to provide the consumer with locking devices that overcome limitations such as more secure theft-proof locking systems.

For example, U.S. Pat. No. 5,386,713 discloses a remote control automobile deadbolt locking device which comprises a transmitter, and a locking mechanism having a deadbolt lock and a spring actuator for controlling the locked and unlocked position of the deadbolt. This automobile deadbolt locking device is designed to effectively lock a car door without a mechanical linkage between the door locking mechanism locking mechanism and the opening mechanism, therefore, intended to provide no mechanical opening of car doors which can result in a more secure car door locking device due to the increased difficulty for an intruder to open the door.

Another example of secure theft-proof locking systems is the vending machine deadbolt locking device disclosed in U.S. Pat. No. 4,270,370. This disclosure pertains to auxiliary deadbolt locking devices which comprise a radio transmitter, and a container locking system having a receiver, a solenoid, and a deadbolt. This deadbolt locking device is also intended to provide a more secure locking means of preventing theft or other unwanted entry into a lockable structure.

Although there have been improvements in the type of locking devices that can be used for controlled entrance into structures such as car doors and vending machines, other suitable remote locking devices for controlled entrance into homes have been contemplated by those skilled in the art. Examples of such locking devices include pet door locking systems as described in U.S. Pat. Nos. 6,141,911 and 5,992,096.

The car door, vending machine, and pet door locking devices are similar in that they are remote locking devices that involve the use of a transmitter that generates a signal to a receiver for locking and unlocking a locking mechanism. The need still exist, however, for improved locking devices that comprise portable units that can be released and reattached to a lockable structure. The locking devices to date comprise a portable transmitter and a receiver unit that is mounted or connected to some portion of the lockable structure wherein the mounted or connected receiver unit can contain a locking mechanism.

It has been found that locking devices that are portable and that comprise components that can be released and reattached to one or more lockable structures, such as cabinets, are extremely desirable in the home for protection of infants, children, pets, or any other individuals to prevent their entry and provide safety from possible harm in the contact of dangerous substances such as medicine, chemicals, household cleaners, paint, and so forth. Portable locking devices can also be used to deter the entrance or exit through lockable gates, outside home fences, and pet doors, in addition to being used to control access to stairwells, home electronics cabinets, toilets, electrical boxes, and large appliances.

Therefore, the present invention relates to portable locking devices which comprise a portable transmitter and portable receiver units that are especially suitable for home use in the locking and unlocking of home cabinets. The portable locking device provides the consumer with a safe and effective manner of protecting individuals, particularly infants and children, at home or at another location that require controlled entrance into a lockable structure. These locking devices are unique locking systems in that they are easy to operate, and can be used as a temporary or permanent device for the controlled entrance into a lockable structure.

### SUMMARY OF THE INVENTION

The present invention is directed to portable locking systems which comprise (a) a portable transmitter, (b) a portable receiver preferably having a locking mechanism connected to the receiver, and (c) an attachment mechanism adapted to releasably affix the portable receiver to a surface. These portable locking systems are especially suitable for use on home cabinets to prevent entry into the cabinets by unauthorized individuals such as infants and children.

It has been found that portable locking systems which comprise a portable transmitter and a portable receiver can be easily transported for use to control the entrance into lockable structures such as home cabinets. The portable transmitter is hand-held or removable from an individual to another individual whereas the portable receiver containing the locking mechanism is removable from the cabinet for reattachment to another cabinet or other lockable structure, thus resulting in a portable locking system that can be used temporarily or permanently at home or transported to another location for use. The portable locking systems of the present invention not only provide for controlled entrance into lockable structures, but can also be used on structures such as locked gates to prevent children or pets from leaving a supervised area.

### BRIEF DESCRIPTION OF THE DRAWINGS

While the specification concludes with claims particularly pointing out and distinctly claiming the subject matter of the present invention, it is believed that the invention can be more readily understood from the following description taken in connection with the accompanying drawings, in which:

FIG. 1 is a perspective representation of portable locking systems of the present invention comprising a manually operated portable transmitter 1 or proximity indicating signal portable transmitters 2, 3, and 4. The manually operated transmitter 1 provides for controlled access by an “authorized entity” into a lockable structure such as a home cabinet, wherein the “authorized entity” controls the locking or unlocking of the cabinet. The proximity indicating signal portable transmitter 2 generates an unlocking signal command when the lockable structure is approached by an “authorized entity” such as a parent. The proximity indicating signal portable transmitters 3 and 4 generate locking signal commands when the lockable structure is approached by “unauthorized entities” such as children and infants. The manually operated transmitter 1 and the proximity indicating signal portable transmitters 2, 3, and 4 are in operable communication with a portable receiver 5 that can be releasably affixed to the lockable cabinet structure. The portable receiver 5 has a locking mechanism 8 connected to the receiver 5 wherein the locking mechanism 8 can be positioned into a locked state 6 or an unlock state 7.

FIG. 2 is a functional diagram of a portable locking system of the present invention comprising a proximity indicating signal portable transmitter 10 and a portable receiver 11. The proximity indicating portable transmitter 10 comprises a transmitter battery 12, a square wave oscillator 13, a radio-frequency (rf) transmitter module 14, and a transmitter antenna 15. The portable receiver 11 comprises an electronic control circuit operating system 16, an electromechanical operating system 17, and a receiver antenna 20. A battery power source 18 is connected to the electronic control circuit operating system 16, wherein the electronic control circuit 16 comprises an rf receiver module 21, an RMS (Root Mean Square) converter 22, a threshold reference 23, a comparator 24, a proximal and distal differentiator 25, a solenoid activation time controller 26, an unlock relay driver 27, and a lock relay driver 28. A battery power source 19 is connected to the electromechanical operating system 17, wherein the electromechanical operating system 17 comprises a solenoid actuator locking mechanism 31, a solenoid power relay 29 that is in operable communication with the electronic control circuit unlock relay driver 27, and a solenoid power relay 30 that is in operable communication with the electronic control circuit lock relay driver 28. The solenoid actuator locking mechanism 31 is suitable for actuation into a locked state 32 or an unlocked state 33.

FIG. 3 is a functional diagram of a portable locking system of the present invention comprising a manually operated portable transmitter 34 and a portable receiver 35. The manually operated portable transmitter 34 comprises a lock/unlock remote switch 36, a lock/unlock control signal generator 37, a multiple channel encoded 38, a lock/unlock indicator light source 39, an rf transmitter module 40, and a transmitter antenna 41. The portable receiver 35 comprises an electronic control circuit operating system 42, an electromechanical operating system 43, and a receiver antenna 44. The electronic control circuit operating system 42 of the portable receiver 35 comprises an if receiver 45, a multiple channel decoder 46, a lock/unlock signal differentiator 47, a solenoid activation time controller 48, an unlock relay driver 49, and a lock relay driver 50. The electromechanical operating system 43 of the portable receiver 35 comprises a solenoid actuator locking mechanism 53, a solenoid power relay 51 that is in operable communication with the electronic control circuit unlock relay driver 49, and a solenoid power relay 52 that is in operable communication with the electronic control circuit lock relay driver 50. The solenoid actuator locking mechanism 53 is suitable for actuation into a locked state 54 or an unlocked state 55.

FIG. 4 is a functional diagram of a portable locking system of the present invention comprising a portable transmitter 56 and a portable receiver 66 wherein the portable receiver 66 provides signals to distinct multiple locking mechanisms 70 and 71 that function to lock and/or unlock corresponding separate lockable structures. The portable transmitter 56 comprises multiple lock/unlock remote switches 57 and 58, multiple lock/unlock control signal generators 59 and 60, multiple lock/unlock indicator light sources 61 an 62, a multiple channel encoder 63, an rf transmitter module 64, and an antenna 65. The portable receiver 66 comprises a receiver antenna 67, an rf receiver module 68, and a multiple channel decoder 69. The locking mechanisms 70 and 71 each respectively comprises solenoid actuators 73 and 75, and lock/unlock differentiator and actuator drivers 72 and 74.

FIG. 5 is a functional diagram of a portable locking system of the present invention comprising a single portable transmitter 76 that provide signals to multiple receivers 77 and 78 for controlled entrance into distinct multiple lockable structures. The portable transmitter 76 comprises multiple lock/unlock remote switches 79 and 80, multiple lock/unlock control signal generators 81 and 82, multiple lock/unlock indicator light sources 83 and 84, a multiple channel encoder 85, an rf transmitter module 86, and a transmitter antenna 87. The receivers 77 and 78 each respectively comprises receiver antenna 88 and 93, rf receiver modules 89 and 94, channel ID decoders 90 and 95, lock/unlock differentiator and actuator drivers 91 and 96, and solenoid actuators 92 and 97.

FIG. 6 is a perspective view of a two component portable attachment mechanism of the present invention wherein the two component attachment mechanism comprises a receiver mount 100 and a surface mount 102. The receiver mount has a female interlocking device 105 constructed of an open end 103 and a closed end 104. The open end 103 and closed end 104 of the female interlocking device 105 facilitate secure fastening of the receiver mount 100 onto a male interlocking device 106 of the surface mount 102.

FIG. 7 is a cross-sectional side view of the receiver mount 100 shown in FIG. 6. This cross-sectional side view of the receiver mount 100 shows oriented configurations of the open end 103 and closed end 104 portions of the female interlocking device 105 when the receiver mount 100 is securely fastened onto a retaining device such as the surface mount 102.

FIG. 8 is a cross-sectional side view of the surface mount 102 shown in FIG. 6. FIG. 8 shows an elevated side view of the male interlocking device 106 onto which the receiver mount 100 is adapted to slide securely.

FIG. 9 is a perspective view of a clip attachment mechanism 110 of the present invention, wherein a portable receiver can be mounted onto the clip 110 that can be attached to a top edge of a lockable structure.

FIG. 10 is a perspective view of an alternate clip 115 that can be used as a receiver mount for releasably affixing a portable receiver to a lockable structure, wherein the clip 115 is a flexible clip having flexibility along flex range 116.

FIG. 11 is a perspective view of an alternate clip 120 that can be used as a receiver mount for releasably affixing a portable receiver wherein the clip 120 has a spring-loaded hinge 121 and is flexible along flex range 122.

FIG. 12 is a perspective view of a two component portable attachment mechanism of the present invention wherein the two component attachment mechanism is shown as a rotating tab and slot configuration 125 having a tab 126 that can be latched into a slot 127 using a sliding, rotating, or turning motion.

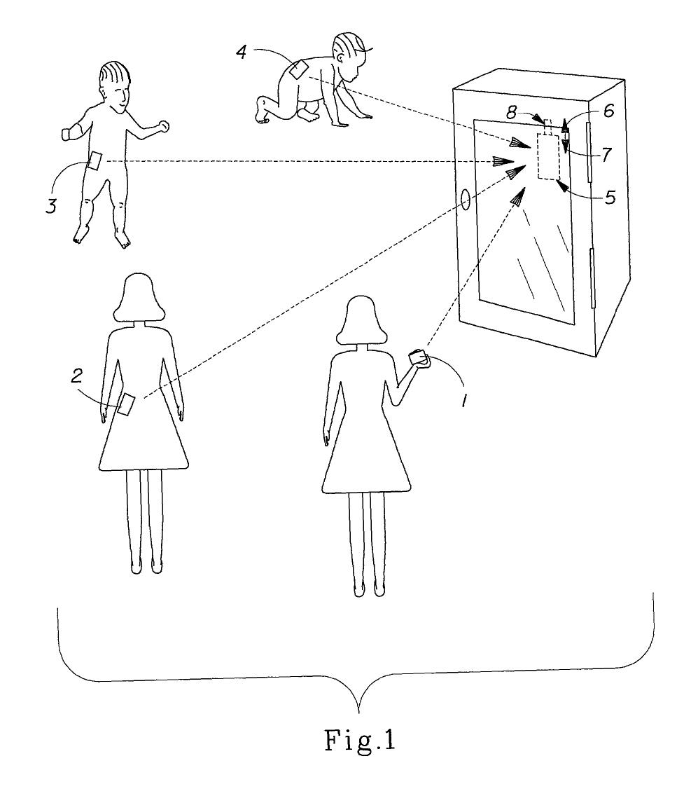

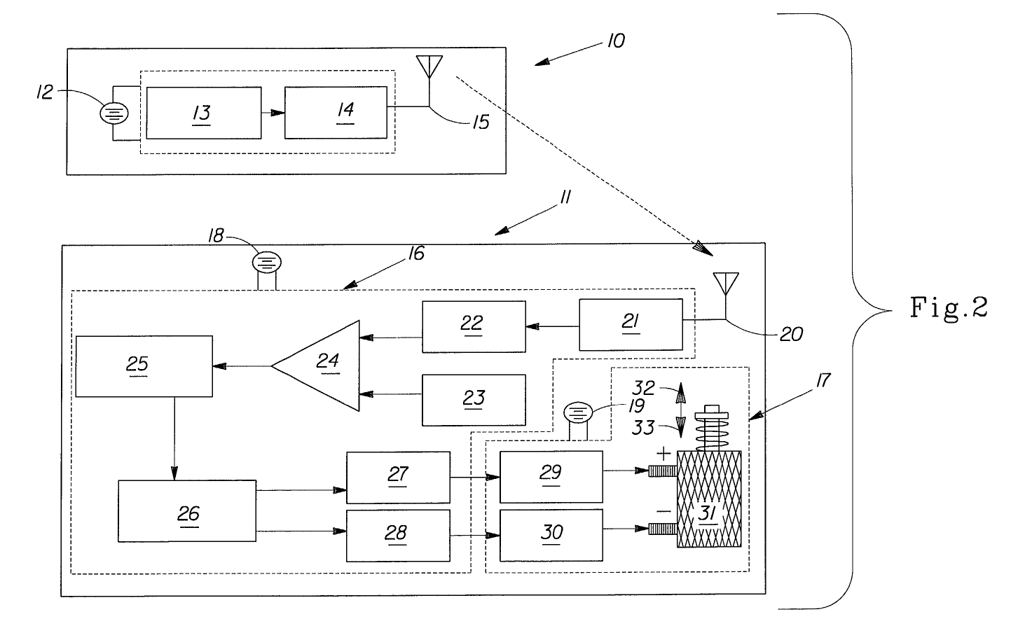

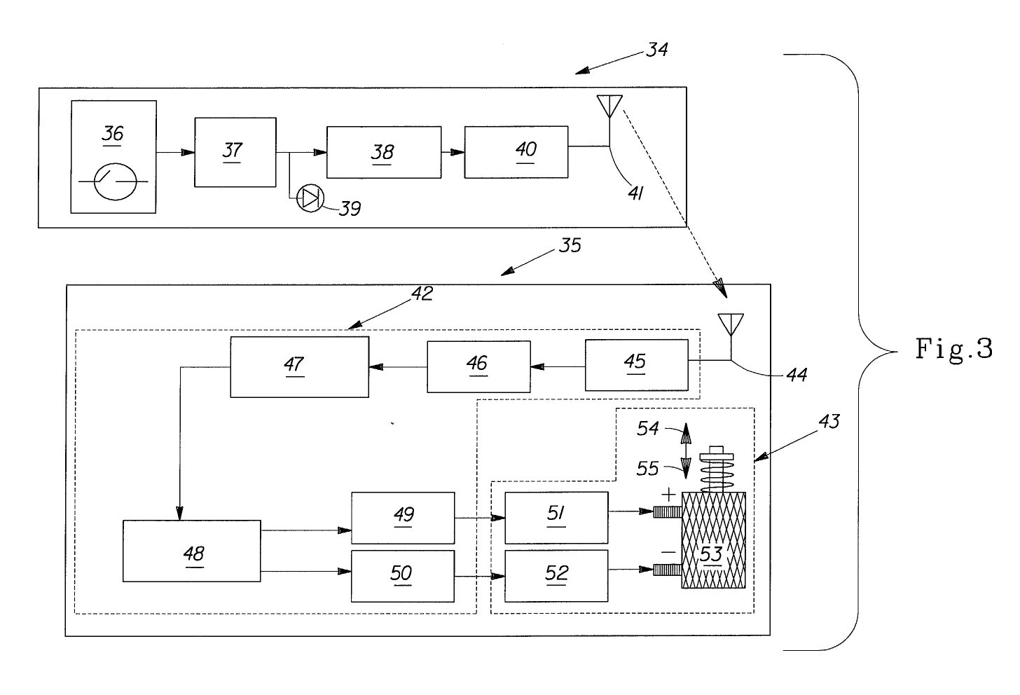

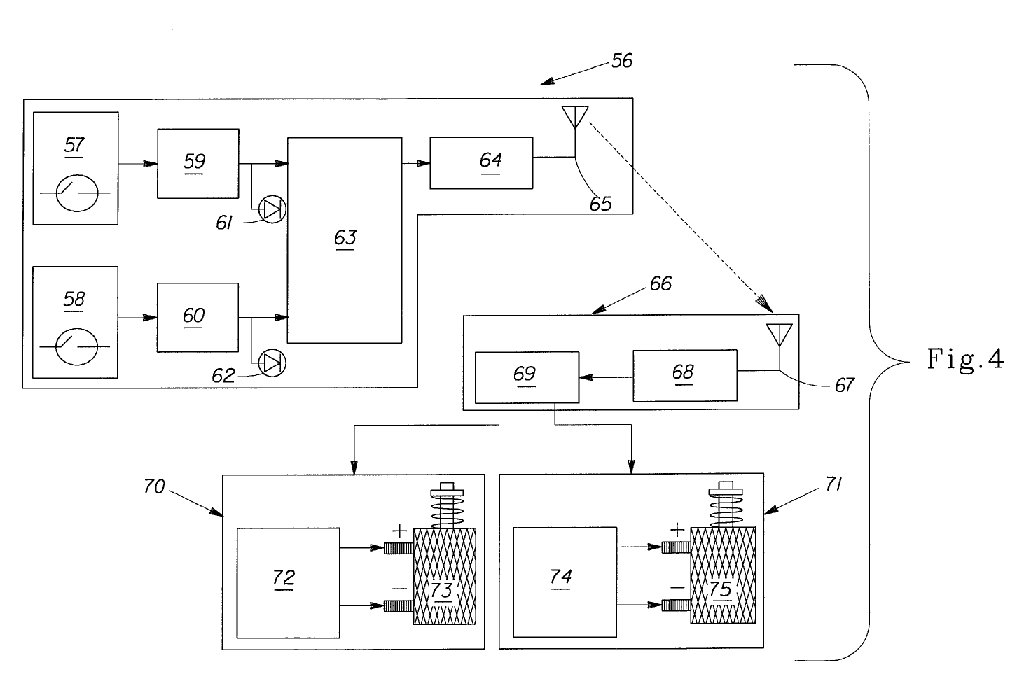

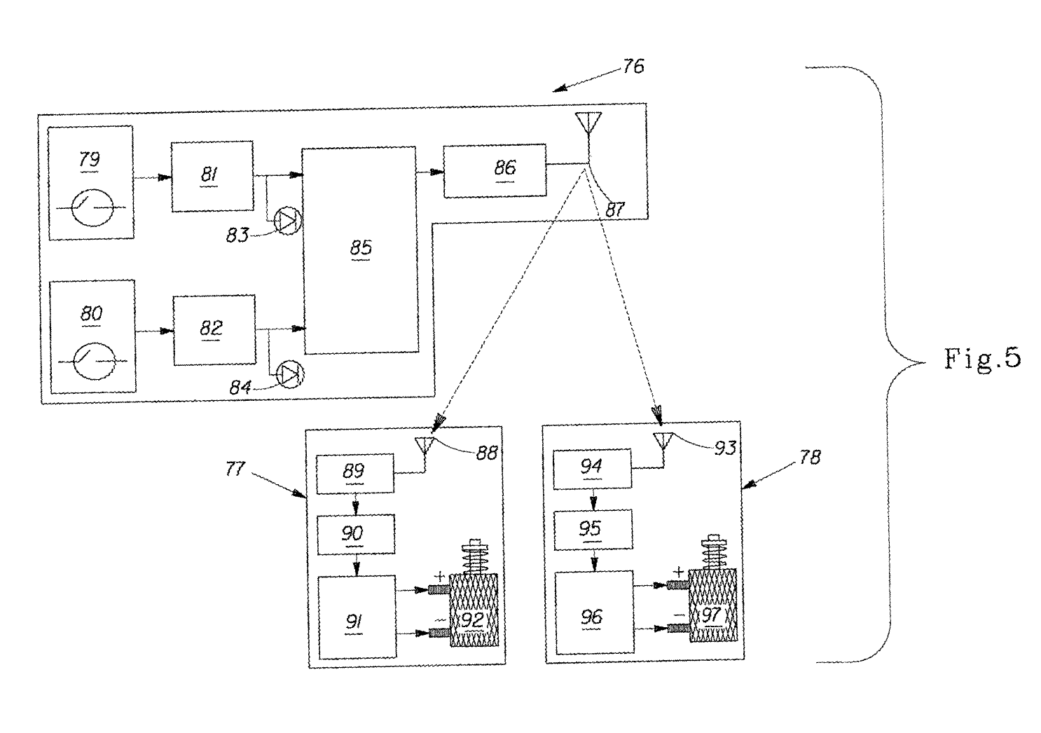

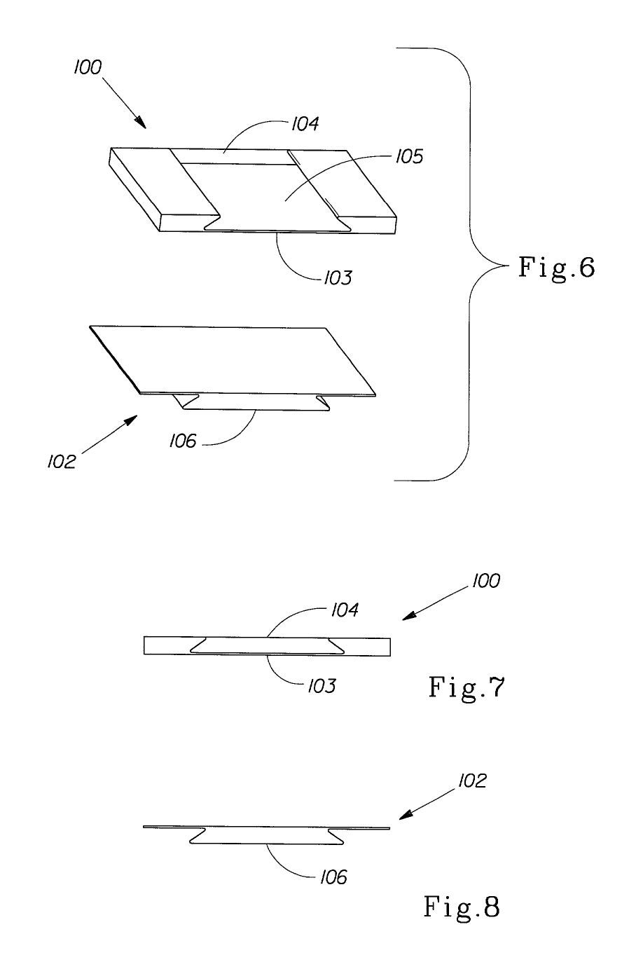

### DETAILED DESCRIPTION OF THE INVENTION

The portable locking systems of the present invention are remote controlled systems that comprise a portable transmitter and a portable receiver. The portable locking systems' transmitter and receiver units provide for portable locking systems that are capable of being attached and reattached for transport of the locking systems from one lockable structure to another lockable structure.

The term “portable” as used herein refers to units or devices which are capable of being removed from one location to another location by way of physically carrying the unit or device or by attaching the unit or device to an individual or object, releasing the unit or device, and reattaching the unit or device to the same individual or object or to another individual or object.

The term “remote controlled” refers to components that are operated to send a signal from one component to another component using signal carrier modalities of ultrasonic signals, and electromagnetic signals such as microwave signals, radio-frequency signals, radio-frequency identification signals (RFID signals), and optical signals including near-infrared radiation signals. The “remote controlled” component can be manually operated or can be an automated component such as a proximity detection remote controlled system. A “proximity detection” system is generally based on the detection of signals having a signal strength above or below a preset or specified threshold value of the system component that detects the signal.

The term “automatic locking” refers to the locking or unlocking of a lockable structure that can occur with and/or without activation by pushing or depressing a switch or button on a control unit to lock or unlock a locking mechanism. For example, “automatic locking” can occur using an automated component such as a proximity detection remote controlled system or by using a proximity detection sub-component in combination with a manually operated remote controlled component.

The term “semi-automatic locking” refers to the locking or unlocking of a lockable structure that can occur by manually depressing each time a switch or button on a control unit to lock or unlock a locking mechanism.

The portable locking systems of the present invention can comprise, consist of, or consist essentially of the elements and limitations of the invention described herein, as well as any of the additional or optional components, or limitations described herein.

### Portable Transmitter

The portable locking systems of the present invention comprise a portable transmitter that is capable of generating a signal that is transmitted to a portable receiver described in detail hereinafter. The portable locking systems herein can operate using an individual portable transmitter or multiple transmitters that are capable of generating signals to one or more portable receivers. The portable transmitter includes any conventional transmitter having circuitry components which provide for signal transmission using known signal transmission frequencies whereby the signal is emitted as a result of manually operating the transmitter or by using a proximity indicating signal transmitter.

The manual operation of the portable transmitters suitable for use herein involves hand-held remote controlled transmitters that are typically operated by pushing one or more button function switches on the transmitter. This process of depressing a button on the portable transmitter generates the output of a signal to the receiver to indicate actuation for locking or unlocking a locking mechanism, thus the locking and unlocking of a lockable structure is capable of being controlled by the simple manipulation of pushing one or more buttons on a manual portable transmitter.

Proximity indicating signal transmitters can be described as automated portable transmitters that output a continuous or intermittent signal detectable by a portable receiver that triggers the locking and unlocking of a locking mechanism. The signal generated by the proximity indicating signal portable transmitter has a signal strength that increases above a preset or otherwise specified signal threshold value of the receiver as the transmitter is moved within a sufficiently close distance toward the receiver, and a signal strength that decreases below a preset or otherwise specified receiver threshold value as the transmitter is moved a sufficient distance away from the receiver. A distance sufficiently close or away from the receiver for a change in signal strength typically corresponds to a distance of from about 2 feet to about 5 feet. These automated portable transmitters can be constructed such that they provide for generated signals as the transmitter is moved a sufficient distance toward or away from the receiver to result in a spontaneous trigger to lock or unlock a locking mechanism.

The circuitry of the portable transmitter typically includes a power source such as a battery, a switch for switching on and off the power source, a transmitter module, an oscillator including resistor/capacitor oscillators and crystal oscillators such as a quartz crystal oscillator, and an antenna. For manually operated portable transmitters, additional components of the circuitry include a J/K Flip Flop which is available as SN7476 from the Texas Instruments, Incorporation located in Dallas Tex. The resistor/capacitor and crystal oscillators are typically used in proximity indicating signal transmitters to generate proximity indicating signals such as sinusoidal, square, and triangular waveform signals. A specific example of an oscillator that generates square waveform signals is the monostable vibrator oscillator which comprises a NE 555 component that is available from Texas Instruments of Dallas, Tex.

Portable transmitters having a transmitting circuit can generate signals having a preselected frequency that is sent from the transmitter to a receiver for the eventual locking or unlocking of a locking mechanism. The signals generated by the portable transmitter include electromagnetic signals, ultrasonic signals, and combinations thereof. Nonlimiting examples of typical electromagnetic signals include microwave signals, radio-frequency signals (rf signals), optical signals including near-infrared radiation signals and low power laser light signals, however, the portable transmitters herein are suitable for generating other electromagnetic signals or any other signal having a preselected frequency.

Portable transmitters that generate radio-frequency signals, near-infrared radiation signals, and other optical signals are preferred. A specific example of a portable transmitter that generates radio-frequency signals is the portable transmitter comprising an if transmitter module adapted to transmit at a frequency of 433 Mega-hertz (MHz) with a power of about 8 milli-watts (mW), and which is available as TX433 from Quality Kits of Ontario, Canada.

The portable transmitters suitable for use herein can also comprise other components such as a lock/unlock control signal generator, a multiple channel encoder, and an indicator light source. Suitable indicator light sources include LED (light emitting diode) light sources which can indicate whether a locking mechanism is in a locked or unlocked state. Specific examples of suitable multiple channel encoders are the microcontroller based GL-104 and GL-116 encoders which are available from the GloLab Corporation located in Wappinger Falls, N.Y.

Although the portable transmitters typically contain a power source such as a battery operated power supply, the portable transmitters can alternatively contain other power sources including solar cells. Specific examples of battery operated power supplies include alkaline batteries, lithium batteries, rechargeable batteries, thin-film batteries, and paper-based printed batteries. The paper-based printed batteries are commercially available as MK3B Power Paper Cells from Power Paper Ltd. located in Kibbutz Einat, Israel.

Preferred portable transmitters suitable for use herein generate radio-frequency signals to provide for the controlled access to lockable structures. The use of radio-frequency transmitted signals is well known to effect operation of devices such as motors and solenoids which can function to actuate the locking and unlocking of locking mechanisms. Among the most commonly employed radio-frequency signals include radio-frequency identification signals (RFID signals) which can be generated using active RFID or passive RFID transmitters. Both active RFID and passive RFID portable transmitters are suitable for use herein wherein the active RFID portable transmitter is typically operated using a battery power supply and the passive RFID portable transmitter functions without the use of a battery.

The portable transmitters suitable for use herein can generate other signals which are typically outside the standard range of radio-frequency signals, wherein such signals include ultrasonic signals, optical signals including near-infrared radiation signals, and any other electromagnetic signal. Regardless of the type of signal generated by the portable transmitter, the transmission is produced such that actuation of the locking and unlocking of a locking mechanism is controlled within a given range distance between the portable transmitter and portable receiver of from about 1 foot to about 50 feet, preferably within a range of from about 2 feet to about 25 feet.

The portable locking systems of the present invention can control the locking and unlocking of a locking mechanism dependent upon the presence of the type of portable transmitter employed (i.e., the ability of the transmitter to communicate with the receiver on a mutually compatible frequency) within the limits of the detection ranges defined herein. In the absence of an appropriate portable transmitter, the portable receiver will not function to actuate the locking mechanism from a locked state to an unlocked state or from an unlocked state to a locked state. Likewise, the presence of portable transmitters which are unable to communicate with the portable receivers described herein will fail to generate a signal that is detectable by the portable receiver for actuation of the locking mechanism.

The portable transmitters suitable for use herein can be associated with an “authorized entity”, the signal therefrom detected by the portable receiver for triggering the unlocking of the locking mechanism when either the transmitter is manually activated by the authorized entity or the transmitter is brought within a sufficiently close distance to the receiver to cause the received signal strength to be above a preset signal threshold value for the receiver. As used herein, the term “authorized entity” refers to individuals such as adults that are allowed access to lockable structures. For example, for access by an “authorized entity” the default state of the locking mechanism is typically in the “locked” state whereby the “authorized entity” can operate the portable locking system to unlock the locking mechanism and gain access to a lockable structure such as a home cabinet containing cleaning supplies or other household supplies which may be dangerous to young children. The default state of the locking mechanism is preferably in the locked state for controlled access of the lockable structure by an “authorized entity” and to prevent access to the structure by an “unauthorized entity”.

The portable transmitters suitable for use herein can also be associated with an “unauthorized entity”, the signal therefrom detected by the portable receiver for triggering the locking of the locking mechanism when the transmitter is brought within a sufficiently close distance to the receiver to cause the received signal strength to be above a preset signal threshold value for the receiver. As used herein, the term “unauthorized entity” refers to individuals such as children or pets that are not allowed access to lockable structures. For example, the default state of the locking mechanism is typically in the “unlocked” state whereby the presence of an “unauthorized entity” carrying or wearing the transmitter will trigger the locking of the locking mechanism so that the “unauthorized entity” (e.g., a toddler) is denied access to a lockable structure such as a home cabinet.

The default state of the locking mechanism can be in a “locked” or “unlocked” state, but preferably the locking mechanism is in an “unlocked” state when controlled entrance of a lockable structure is regulated by the portable locking systems of the present invention to deny access to the lockable structure by an “unauthorized entity” and to provide convenient unobstructed access to the lockable structure by an “authorized entity”. The controlled access provided by the portable transmitters for “authorized” and “unauthorized” users allows safe and preventive techniques in stopping individuals, particularly infants and children, from opening lockable structures that can contain harmful products.

The signal source used to generate the output signals of the portable transmitters of the present invention can be configured to produce coded signals such that the portable transmitters are unique and distinguishable from one another. Typically, a separate code is assigned to each portable transmitter, and individual receiver units, for the operation of one or more portable transmitters and receivers to control the authorized or unauthorized access to one or more lockable structures by multiple entities. Portable transmitters having an assigned coded signal can transmit a specific identification code to a receiver, thereby minimizing the occurrence of an inappropriate transmitter participating in the locking or unlocking of a lockable structure. The portable transmitters with coded signals may also provide for the tracking of the source and use of a specific transmitter, and the reduction of attempted misuse to operate a prohibited lockable structure. Optionally, coded portable transmitters can be programmed to assist in the performance of other functions in addition to locking and unlocking a locking mechanism wherein the additional functions include turning on and off interior lights, activating a visual or audible alarm system, tracking children or pets, transmitting sound or voice data, and so forth.

The portable transmitters suitable for use herein are enclosed within a housing to result in portable transmitters that resemble identification badges, portable boxes, bracelets, wristbands, postage stamps, key fobs, necklaces, belt buckles, and so forth. The material from which the housing is constructed includes plastics such as polyethylene and Torlon plastic, foams, fabrics or cloths, cardboard, glass, wood and other natural products, and combinations thereof. A specific example of a commercially available Torlon plastic material is 7130 Torlon plastic available from the Amoco Company located in Atlanta, Ga. As stated, the portable transmitters are made such that they are in the form of objects such as identification badges and portable boxes, however, the portable transmitters can be made into various shapes and sizes, examples of which include square, rectangular, oval, elliptical, diamond, and elongated cylindrical portable transmitters that are sized to be worn or carried by infants, pets, children, adults, or any other animate subject. The housing not only enhances the cosmetic and/or ergonomic appeal of the portable transmitters, but also serves to protect the transmitters' circuitry from moisture and contamination.

### Portable Receiver

The portable locking systems of the present invention comprise a portable receiver that operably communicates with the portable transmitter to primarily control entrance into lockable structures. The portable receiver preferably has a locking mechanism attached to the receiver unit wherein the locking mechanism is positioned in a locked or unlocked state dependent on the signal that is transmitted by the portable transmitter and then processed by the portable receiver. The combination of a portable transmitter and a portable receiver having an attached locking mechanism provide for portable locking systems that are easy to operate, convenient, transportable, and especially effective in the controlled entrance of lockable structures such as home cabinets. The portable receiver can be used as an individual portable receiver unit or as multiple receiver units with one or more portable transmitters for the controlled entrance into one or more lockable structures by multiple entities.

The portable receivers suitable for use herein include any known or otherwise effective receiver unit that has circuitry components designed to receive and process signals transmitted by the portable transmitter, and that is preferably constructed such that the receiver has a locking mechanism attached to the receiver. In this context, the phrase “a locking mechanism attached to the receiver” refers to integral connection of the locking mechanism to any connectable component of the receiver such as a receiver solenoid actuator component, a receiver electromagnet actuator component, a receiver housing component, and so forth. It has been found that receiver units having locking mechanisms as an integral component of the receiver provide the consumer with a new and highly effective approach for the protection against unwanted entry into a lockable structure in addition to the prevention of premature exit from a confined area. These receiver units with their locking mechanism can be attached and reattached to lockable structures, thereby providing the consumer with a unique method of using a locking device for example on one lockable structure and then removing the locking system for use on another lockable structure.

Nonlimiting examples of suitable portable receivers include those receivers that can process radio-frequency signals, microwave signals, optical signals including near-infrared radiation signals, ultrasonic signals, and any other transmittable signal to result in the locking and unlocking of the locking mechanism. Portable receivers that can process radio-frequency signals are preferred. Portable receivers comprising an rf receiver module can be constructed such that it uses a different rf device than that used in the portable transmitter, however both the portable receiver and portable transmitter can include an rf device adapted to transmit at a frequency of 433 Mega-hertz MHz) with a power of about 8 milli-watts (mW) such as the TX433 rf device available from Quality Kits of Ontario, Canada.

In certain embodiments of the present invention comprising a passive RFID portable transmitter, the receiver may include a transmitter module that produces a radio-frequency signal that inductively powers the passive RFID portable transmitter when this portable transmitter is within range of the receiver.

In addition to the locking mechanism, preferred portable receivers will generally have an electronic control circuit and an electromechanical operating system which is designed to actuate the locking mechanism. The components of the portable receiver are capable of receiving and processing signals generated by the portable transmitter wherein the received signals are sent from one receiver component to another. For example, components of the electromechanical operating system receive signals from components of the electronic control circuit portion of the receiver, and then carry a signal to the locking mechanism for actuation of the locking mechanism into a locked or unlocked state.

Nonlimiting examples of components of the electronic control circuit include receiver modules such as rf receiver modules described hereinabove, RMS (Root Mean Square) converter, a threshold reference voltage, a comparator, a proximal and distal differentiator, lock/unlock signal differentiator, solenoid activation time controller, lock/unlock relay driver, a multiple channel decoder, and combinations thereof. A specific example of a suitable threshold reference voltage is the REF192 reference voltage which is available from Analog Devices located in Norwood, Mass. A specific example of a suitable solenoid activation time controller is the monostable multivibrator NE 556 controller available from Texas Instruments of Dallas, Tex. Specific examples of suitable multiple channel decoders are the microcontroller based GL-104 and GL-116 decoders which are available from GloLab of Wappinger Falls, N.Y.

Nonlimiting examples of components of the electromechanical operating system include actuators such as standard solenoids, rotary solenoids, latching solenoids, electromagnets, AC and DC stepping motors, servos, and combinations thereof. Portable receivers comprising solenoid actuators can also comprise a solenoid power relay that functions to provide separate power supply to the solenoid actuator.

The actuation of the locking mechanism for the locking and unlocking of a lockable structure can be accomplished in several ways: 1) a preselected signal is transmitted by the portable transmitter as the transmitter is moved within a proximity detection range of the portable receiver, the signal is then processed by the components of the portable receiver for actuation of the locking mechanism into a locked or unlocked state when the received signal strength exceeds a predetermined signal threshold value for the receiver, or 2) a preselected signal is transmitted by the portable transmitter at any distance in the vicinity of the portable receiver by manually activating a button or switch on the transmitter, the portable receiver detects the signal, then the signal is processed by the components of the portable receiver for actuation of the locking mechanism into a locked or unlocked state.

In preferred embodiments of the present invention, the receiver functions to perform a reverse operation of the locking mechanism into a state opposite its original locked or unlocked state. This reverse operation of the locking mechanism into a state opposite its originally actuated state occurs when the portable transmitter is moved a sufficient distance away from the receiver such that the received signal strength decreases to a level below a preset signal threshold value for the receiver, or when the portable transmitter is manually operated to send an opposite command. A delay timer can be included to delay the reversal of the locking mechanism from its original actuated state, wherein the delay timer provides for the reversal position of the locking mechanism at a preset time that follows the originally actuated position. In other words, after being in an original locked or unlocked state, a delay timer can be used to control the time of actuating the locking mechanism into a reverse position. The portable receiver can also provide for the locking mechanism to remain in its original locked or unlocked state until the locking mechanism is manually reset as, for example, an individual manually pushing the locking mechanism into a reverse position. Alternatively, the portable receiver can be coded or equipped with a mechanical component such as a standard key locking device that will allow manual operation of the locking mechanism.

Like the portable transmitters, the portable receiver unit can additionally comprise a status indicating mechanism to indicate the status of a locking mechanism (i.e., whether the locking mechanism is in a locked vs. an unlocked state) and/or to indicate to a user that the locking or unlocking has occurred in real-time. Suitable status indicating mechanisms include indicator lights such as LEDs, and sound emitting elements that produce an audible sound at the time of successful locking or unlocking of the locking mechanism.

Like the portable transmitters, the portable receivers suitable for use herein operate using power supply equipment such as batteries and solar cells. The portable receiver's electronic control circuit sends an electrical signal to, for example, a solenoid component of the portable receiver which in turn actuates the locking mechanism. Although the portable receivers are preferably operated using battery or solar cell power supplies, the portable receivers can also be connected to electrical outlets or connected to standard power plugs for a source of electrical current.

Suitable portable receiver units are enclosed within a housing that can be used for encasing the portable transmitters described herein. The housing, as previously described, can also be made from materials known in the art such as plastic materials and can be constructed such that the portable receivers resemble objects such as portable boxes. Preferably, the housing is made from non-rf attenuating materials. The size and shape of the housed portable receivers can also vary provided that the housed portable receivers are of a size and shape that can contain a locking mechanism, and that can fit onto a lockable structure for the controlled entrance into the structure.

Preferred portable receivers suitable for use herein have been described as those having a locking mechanism attached to the receiver. It is contemplated, however, that portable receivers that function to trigger the locking and unlocking of any type of locking mechanism are suitable for use herein, provided that these portable receivers can also be attached and reattached to lockable structures, thereby adapted to be releasably affixed to a surface. In other words, suitable portable receivers include releasable portable receivers having a locking mechanism attached to the receiver and releasable portable receivers that trigger detached locking mechanisms. Nonlimiting examples of releasable portable receivers that function to control a detached locking mechanism include releasable portable receivers that control the locking and unlocking of locking mechanism that are attached or mechanically linked to a lockable structure, specific nonlimiting examples of such locking mechanisms include door locks, car door locks, building locks, home entrance locks, cabinet locks, vending machine locks, and so forth.

### Locking Mechanism

The portable locking systems of the present invention comprise a locking mechanism that is preferably connected to the portable receivers described herein. The locking mechanism is capable of being actuated into a locked or unlocked position and remain in the position until a manual or automatic signal to reverse the lock or unlocked state is initiated, thereby providing for the automatic or semiautomatic locking and unlocking of a lockable structure.

Suitable locking mechanisms include locking bars, bolts, plungers, or any other securing material, that can be actuated for engaging and releasing a lockable structure. The material from which the locking bars, bolts, plungers, and any other locking mechanism is constructed includes plastics, metal, stainless steel, ferritic materials, or any other composite material that is sufficiently strong to cause the locking and unlocking of a lockable structure.

The locking mechanism can include a locking element such as a locking bar or bolt which is triggered into a locked or unlocked state by an actuator, or the locking mechanism can be constructed of an actuator locking element as for example a solenoid actuator device. Nonlimiting examples of solenoid actuator devices that are suitable for use as a locking mechanism herein include latch type solenoids and rotary solenoids. A specific example of a latch type solenoid is the M-22 series latch solenoid which comprises a plunger and actuator components, and which is available as M-22PL 012 DC P solenoid from the Pontiac Coil, Incorporation located in Searcy, Ark.

### Attachment Mechanism

The portable locking systems of the present invention comprise portable transmitters and portable receiver units as described hereinabove, wherein each of these units are enclosed within separate housings and are adapted to be releasably attached to an entity or surface. The advantage of portable units with attachment mechanisms is that these units can be attached, removed, and reattached giving them increased functionality from flexibility and reuseability standpoints. Most portable locking systems comprise a portable transmitter and a receiver connected or mounted to some portion of a lockable structure, whereas the portable locking systems of the present invention comprise portable transmitters and portable receivers wherein each are adapted to be releasably attached to an entity or surface, allowing each portable unit to be transported from one entity or surface to another, reused on the same entity or surface, or even temporarily attached for storage of the units.

The attachment mechanisms can be adhered or fastened to the housing of the portable transmitters and portable receivers such that the portable units are capable of being attached and reattached to an individual or inanimate object. The attachment mechanisms provide for attachment in no particular manner so long as the portable units can be released for reattachment if desired, therefore the attachment means include hanging, adhesively attaching, clipping, clamping, pinning, hooking, snapping, buckling, buttoning, and the like, and combinations of these attachment mechanisms.

It is contemplated, however, that the portable transmitters herein can be operated without an attachment mechanism adhered to the transmitter. For example, the portable transmitter can be hand carried or carried in an article of clothing (e.g., a pocket) or an accessory (e.g., a purse). The portable transmitters are also suitable for being associated with or as an integral part of an absorbent article such as a disposable diaper or training pants.

Preferably, the attachment mechanism is a portable two component attachment system which comprises a portable receiver having a receiver mount preferably permanently affixed to or integral with a housing encasing the receiver, and a surface mount with which the receiver can be releasably engaged and that is also adapted to be attached to a surface of a lockable structure. The engagement of the receiver mount to the surface mount can be accomplished in various ways such as adhesively attaching, clipping, clamping, pinning, hooking, snapping, buckling, buttoning, geometrically locking, or wedging the receiver to the surface mount, and combinations of these attachment mechanisms. Regardless of the specific attachment mechanism employed, the receiver and surface mounting units are joined such that they are securely attached together, yet the portable receiver is easily releasable from the surface mount and the surface mount is preferably easily releasable from an attached surface.

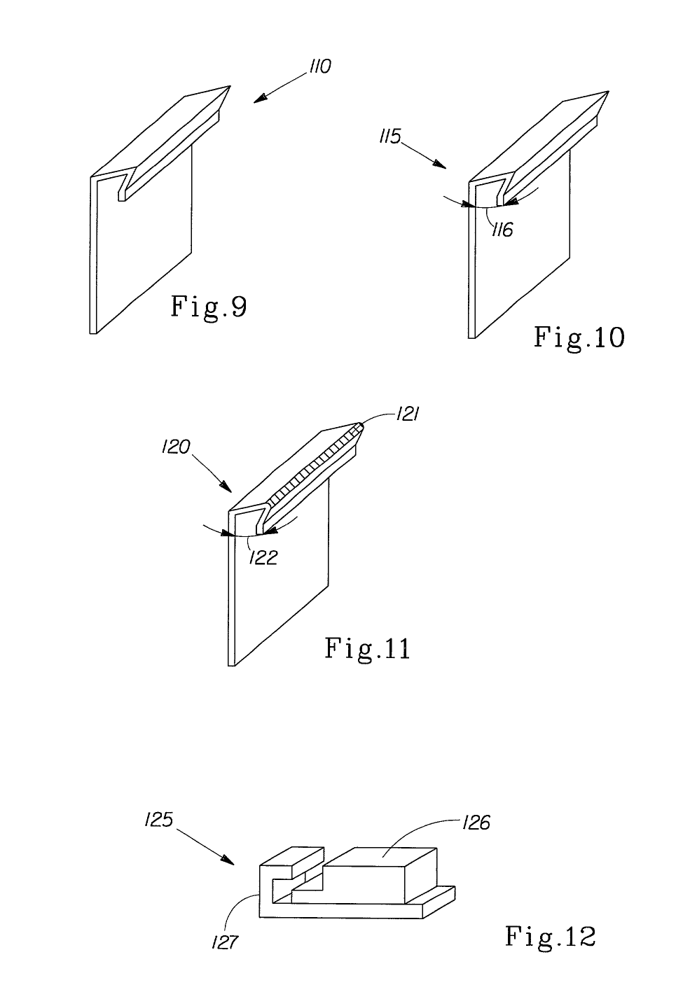

To illustrate the connection of a preferred embodiment of a portable two component attachment system, the receiver mount can comprise a “female” interlocking device while the surface mount comprises a “male” interlocking device wherein the female interlocking device is adapted to securely and releasably fit within the male interlocking device. In an exemplary embodiment depicted in FIG. 6, the attachment mechanism comprises a surface mount having a male interlocking device onto which a corresponding female interlocking device on the receiver mount is adapted to slide securely. The female interlocking device of the receiver mount has at least one open end and one closed end, wherein the closed end facilitates the retention of the male portion of the surface mount. Preferably, the receiver mount is oriented such that the open end 103 of the female interlocking device is on the bottom and the closed end 104 is oriented upwards to retain the receiver mount against gravity. The portable receiver can be disengaged from the surface mount by sliding the portable receiver unit up and off of the surface mount. Alternatively, the receiver mount can comprise a clip having a negative interference when applied to the top edge of a cabinet door, as shown in FIGS. 9-11. In another exemplary embodiment, the receiver and surface mounts are engaged in a rotating arrangement such as rotating arrangements commonly used to secure home smoke detectors to ceiling mounting plates. It is contemplated that a multiplicity of surface mounts can be employed on a variety of lockable structures in addition to the portable locking systems herein comprising one or more portable receiver units that are suitable for mounting in the surface mounts described herein.

Materials suitable for attachment of the portable transmitters, portable receivers, and portable two component attachment system include any known or otherwise effective material that can facilitate connection between the portable units and an individual or lockable structure wherein the portable units can be disconnected for reuse. The attachment mechanisms are preferably used such that the portable transmitters and portable receivers are attached and reattached, however, the attachment mechanisms can also provide for the permanent attachment of the portable units. Specific examples of attachment materials include clips including spring-loaded clips, snaps, buttons, safety pins, clamps, hooks, strings including lanyard string materials, adhesives, hook-and-loop fastening systems such as VELCRO®, and combinations thereof. An example of a suitable adhesive attachment material includes the adhesive Power Strips which are available from the 3M Corporation located in Minneapolis, Minn.

### Mode of Operation

The portable locking systems of the present invention are designed to provide for the controlled entrance into lockable structures such as home cabinets. However, the portable locking systems are also suitable for use in other modes of operation such as the locking and unlocking of other lockable structures such as fences, child gates, buildings, doors, vending machines, and so forth. Preferably, the portable locking systems of the present invention permit the access by authorized entities and/or deny access by unauthorized entities to lockable structures.

When the portable locking systems of the present invention provide for authorized access of a lockable structure, the portable locking system is designed such that the portable transmitter generates a signal to the portable receiver to result in the unlocking of the structure. The structure can be left unlocked or locked automatically or semi-automatically after permissible access. Automatic locking can occur when an entity carrying or wearing the portable transmitter moves a sufficient distance away from the portable receiver to effect a decrease in a received signal strength below a preset signal threshold value for the receiver. Semi-automatic locking can occur by depressing a switch or button on the portable transmitter to generate a signal to the portable receiver for positioning the attached locking mechanism into a locked state.

Denial of access to lockable structures by unauthorized users typically prevents children, unwanted pets, cognitive-impaired adults, thieves, and so forth, from gaining access to contents within a lockable structure or just from entering or exiting the structure. The portable locking systems of the present invention prevent unauthorized access by providing for the automatic or semi-automatic locking of an unlocked structure when an unauthorized entity is in the vicinity of the structure, and the unlocking of the structure when the unauthorized entity is outside the selected locking range of the locking system. Alternatively, if the lockable structure is left in a locked state after access from an authorized user, the portable locking systems of the present invention can operate so that the structure remains locked when approached by an unauthorized entity and, therefore, unlocked when the unauthorized entity is again outside the selected locking range of the locking system.

Accordingly, the portable locking systems of the present invention are transportable units that provide a remote operation of locking and unlocking lockable structures. It has been found that these portable locking systems operate using portable transmitters that can generate signals for proximity detection or by manually depressing a button or switch on the transmitter, wherein the transmitter can transmit the signal at a range of from about 1 foot to about 50 feet. The portable transmitters can be hand-carried or fastened to an entity and are in operable communication with portable receivers that can be attached and reattached to a lockable structure, resulting in portable locking systems that can be transferred from one location to another for the remote operation of controlled entrance into lockable structures.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

### Example 1

The following is an illustrative example of a portable locking system of the present invention which comprises a proximity indicating signal portable transmitter and a portable receiver. The proximity indicating signal portable transmitter and portable receiver operably communicate to control access to a lockable structure such as a home cabinet.

The proximity indicating signal portable transmitter comprises an rf transmitter module, an antenna, a battery, and a square wave oscillator. The rf transmitter module can be obtained from Quality Kits under the tradename TX433. This TX433 rf transmitter module is adapted to transmit at a frequency of 433 MHz with a power of about 8 mW. The square wave oscillator comprises a NE 555 component that is available from Texas Instruments, and produces a signal having a frequency of 1.27 kilo-hertz (kHz) and a 2.7 volt peak-to-peak value. The rf transmitter module takes the square wave signal produced by the square wave oscillator and generates an AM (Amplitude Modulation) signal according to the amplitude of the incoming square wave signal. The AM signal is then broadcast to a portable receiver via the antenna.

The portable receiver comprises an rf receiver module that receives through a receiver antenna the AM signal transmitted by the portable transmitter, delivering the signal to an RMS converter. A suitable rf receiver module of the portable receiver is the RX433 rf device from Quality Kits. The RMS converter takes the AM demodulated square wave signal from the rf receiver module and generates an RMS value (Root Mean Square value). Depending on the proximity of the portable transmitter, the amplitude of this demodulated signal varies. A comparator circuit is included in the portable receiver to compare the RMS output signal with a reference voltage (i.e., a preset threshold value produced by a reference voltage such as REF192 from Analog Devices), and then the comparator generates a digital logic signal. The digital logic signal indicates whether the received signal strength has exceeded the receiver threshold value and, therefore, whether the portable transmitter is within the proximity detection range.

A proximal/distal differentiator of the portable receiver then takes the digital logic signal and generates a “lock” or “unlock” signal. When the portable locking system is operating for entry into a lockable structure by an authorized entity, an “unlock” signal is generated by the portable transmitter and processed through the portable receiver when the received signal strength increases above a preset threshold value for the receiver. When the portable locking system is operating to deny entry into a lockable structure by an unauthorized entity, a “lock” signal is generated by the portable transmitter and processed through the portable receiver when the received signal strength increases above a preset threshold value for the receiver. A solenoid activation time controller such as monostable multivibrator NE 556 from Texas Instruments can be employed to control the timing width of the lock/unlock signals generated by the proximal/distal differentiator. For example, a 15 milli-second pulse width is long enough to drive the solenoid toward a lock or unlock status, but is short enough to prevent premature exhaustion of a receiver power source such as a receiver battery. The lock or unlock pulse signals generated by the time controller trigger the actuation of a latch-type solenoid to move a cylindrical plunger to a lock or unlock state for controlled entrance into a lockable structure.

### Example 2

The following is an illustrative example of a portable locking system of the present invention which comprises a manually operable portable transmitter equipped with an rf transmitter module and a portable receiver equipped with an rf receiver module and a battery power source. The portable transmitter of this example also includes a battery power source and is operated by an authorized individual who presses, or otherwise manually triggers, a mechanism to produce “lock” and/or “unlock” signals. A suitable mechanism is the J/K Flip Flop which is available from Texas Instruments, and which produces a digital logic signal when it is activated and also activates or deactivates a cabinet lock status LED. Lock and unlock signals are separately transmitted to avoid logic inversion. A multiple channel encoder such as microcontroller GL-104 encoder from GloLab generates at least one serial data code channel for each of the lock and unlock command signals. The encoded rf signal is then transmitted to the portable receiver.

The portable receiver is equipped with a multiple channel decoder such as microcontroller GL-104 decoder from GloLab that processes the encoded rf signal transmitted by the portable transmitter. The lock or unlock rf signal is then processed using a lock/unlock signal differentiator that distinguishes a lock command as compared to an unlock command and generates the lock or unlock control signal for triggering a locking mechanism actuated by a solenoid activation time controller. A solenoid activation time controller such as monostable multivibrator NE 556 from Texas Instruments can be employed to control the timing width of the lock/unlock signals generated by the signal differentiator. For example, a 15 milli-second pulse width is long enough to drive the solenoid toward a lock or unlock status, but is short enough to prevent premature exhaustion of the receiver battery. The lock or unlock pulse signals generated by the time controller trigger the actuation of a latch-type solenoid to move a cylindrical plunger to a lock or unlock state for controlled entrance into a lockable structure.

### Example 3

The following is an illustrative example of a portable locking system of the present invention which comprises a single portable receiver that provides signals to distinct multiple locking mechanisms that can lock/unlock corresponding separate lockable structures. Suitable portable transmitter and portable receiver units are those described in Example 2 hereinabove. In this example, the decoded signal is sent to multiple lock/unlock differentiators that drive separate solenoid actuator locking mechanisms. One or more of the locking mechanisms may be remotely connected to the receiver via wiring.

### Example 4

The following is an illustrative example of a portable locking system of the present invention which comprises a single portable transmitter that provides signals to multiple portable receivers to actuate the locking/unlocking of separate lockable structures. In this example, each portable receiver can be controlled by a single transmitter having separate switches for generating signals to the portable receivers. The portable transmitter is also equipped with separate signal control generators such that the separate switches produces digital logic signals that are sent from each switch to a corresponding signal control generator and then to a multiple channel encoder such as a GL-104 encoder which is available from GloLab. The multiple channel encoder combines the address code of each lockable structure in addition to the lock/unlock signals for each lockable structure. The locking or unlocking of a locking mechanism for controlled entrance into a lockable structure occurs via a lock or unlock command signal from the transmitter multiple channel encoder wherein the command signal is then sent to other components of the transmitter such as the rf transmitter module and antenna for transmission of the command signal to a portable receiver unit such as that described in Example 2 hereinabove.

Alternatively, the multiple portable receivers can receive signals from multiple portable transmitters wherein each portable transmitter is equipped with a separate lock/unlock signal control generator. The mode of operation for each transmitter and receiver is similar to that described for the transmitter and receiver units of Example 2.

What is claimed is:

1. A portable locking system comprising:
(a) a portable transmitter;
(b) a portable receiver; and
(c) an attachment mechanism adapted to releasably affix the portable receiver to a surface.

2. The portable locking system of claim 1 wherein the portable transmitter emits a signal that includes radio-frequency signals, near-infrared radiation signals, optical signals, microwave signals, ultrasonic signals, or combinations thereof.

3. The portable locking system of claim 2 wherein the signal emitted by the portable transmitter is a continuous signal.

4. The portable locking system of claim 2 wherein the signal emitted by the portable transmitter is an intermittent signal.

5. The portable locking system of claim 2 wherein the portable transmitter can emit the signal in a range of from about 1 foot to about 50 feet.

6. The portable locking system of claim 1 wherein the portable transmitter is a manually operated portable transmitter.

7. The portable locking system of claim 1 wherein the portable transmitter is a proximity indicating signal portable transmitter.

8. The portable locking system of claim 1 wherein the portable locking system further comprises a locking mechanism.

9. The portable locking system of claim 8 wherein the locking mechanism is locked when the received signal strength from the proximity indicating signal transmitter increases above a preset receiver threshold value.

10. The portable locking system of claim 8 wherein the locking mechanism is unlocked when the received signal strength from the proximity indicating signal transmitter increases above a preset receiver threshold value.

11. The portable locking system of claim 8 wherein the portable receiver further comprises a status indicating mechanism indicating a lock or unlock status of the locking mechanism.

12. The portable locking system of claim 8 wherein the locking mechanism is connected to the receiver.

13. The portable locking system of claim 1 wherein the attachment mechanism is a two component attachment mechanism comprising a receiver mount and a surface mount.

14. The portable locking system of claim 13 wherein the receiver mount is releasably affixed to the surface mount and the surface mount is releasably affixed to a surface using attachment mechanisms selected from the group consisting of clips, snaps, buttons, safety pins, clamps, hooks, strings, adhesives, hook-and-loop fastening systems, geometric locks, welds, and mixtures thereof.

15. The portable locking system of claim 1 wherein the portable transmitter and portable receiver are enclosed within separate housings having the attachment mechanism attached thereto.

16. The portable locking system of claim 15 wherein the attachment mechanism is selected from the group consisting of clips, snaps, buttons, safety pins, clamps, hooks, strings, adhesives, hook-and-loop fastening systems, and mixtures thereof.

17. A method of controlling the entrance into a lockable structure, the method comprising the steps of:
(a) releasably affixing a portable receiver to a surface of the lockable structure;
(b) generating a signal from a portable transmitter;
(c) processing the signal through the portable receiver wherein the portable receiver has a locking mechanism connected to the receiver; and
(d) actuating the locking mechanism into a locked or unlocked position.

18. The method of claim 17 wherein the portable receiver is releasably affixed to the surface of the lockable structure using a two component attachment mechanism comprising a receiver mount and a surface mount.

19. The method of claim 18 wherein the receiver mount is releasably affixed to the surface mount and the surface mount is releasably affixed to the surface of the lockable structure, and wherein the attachment mechanism is selected from the group consisting of clips, snaps, buttons, safety pins, clamps, hooks, strings, adhesives, hook-and-loop fastening systems, geometric locks, wedgers, and mixtures thereof.

20. The method of claim 17 wherein the portable receiver is releasably affixed to the surface of the lockable structure using an attachment mechanism selected from the group consisting of clips, snaps, buttons, safety pins, clamps, hooks, strings, adhesives, hook-and-loop fastening systems, and mixtures thereof.
